(19) United States
(12) Patent Application Publication
(10) Pub. No.: US 2003/0120370 A1
(43) Pub. Date: Jun. 26, 2003

(54) Electric power consumer data analyzing method

(75) Inventors: Masashi Kitayama, Tokyo (JP); Ryunosuke Matsubara, Tokyo (JP); Yoshio Izui, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/150,076

(22) Filed: May 20, 2002

(30) Foreign Application Priority Data
Dec. 12, 2001 (JP) 2001-378688

(51) Int. Cl. G06F 7/00

(52) U.S. Cl. 700/100

(57) ABSTRACT

Data on electric energy consumption of respective electric power consumers are collected in a predetermined period. Total electric energy consumption by the electric power consumers are classified into m levels. Degree of load contribution of the electric power consumers in consideration of at least load factors of the load factors which are ratios of average values of the consumed electric energy of the electric power consumers to the maximum values of the consumed electric energy and uniformity coefficient which are ratios of sum totals of the maximum values of the consumed electric energy of the electric power consumers belonging to the same level of consumed electric energy in the period are classified into n levels, the respective electric power consumers are divided into m×n number of classes and the result is displayed or stored.

### FIELD OF THE INVENTION

The present invention relates to an electric power consumer data analyzing method of analyzing electric power demand pattern on the basis of data on electric energy consumption in the past of a client (“electric power customer”), and evaluating the electric power consumer in the electric power market when viewed from an electric power supplier.

### BACKGROUND OF THE INVENTION

A method of forming a client value map has been described in, e.g., Japanese Patent Laid-Open No. 2000-187690. This prior art method is oriented for the clients of retail sales. As purchase data of the clients, data which consists of a purchase merchandise code, a quantity, a purchase price, and a purchase date is used. Degree of contribution to money of or merchandise in a specific market is dependent on quantities of purchased merchandise of clients to classify the clients into m levels on the basis of the purchase data. Degree of royalty or adherence to respective brands of merchandise of clients is dependent on the degree of concentration of purchase brand types to classify the clients into n levels on the basis of the purchase data. The clients are divided into m×n cells on the basis of these classifications to form a client value map.

As already mentioned above, the prior art method is oriented for the clients of retail sales. When the method is to be applied to the field of the electric power, data such as the quantity, the purchase price, and the purchase date does not exist because the field of the electric power is characterized in that such data is continuously supplied to a client under conditions determined by a contract. Thus, there exists a problem that the prior art method cannot be applied as it is to the field of the electric power.

### SUMMARY OF THE INVENTION

It is an object of the present invention to provide a novel method of analyzing an electric power demand pattern on the basis of data on electric energy consumption in the past of an electric power customer, and evaluating the electric power consumer in an electric power market when viewed from an electric power supplier.

According to the present invention, there is provided an electric power consumer data analyzing method that is realized in the electric power market in which a plurality of electric power consumers purchase electric power from an electric power supplier. This method comprises an electric power consumer data collection step of collecting data on the electric energy consumption by the respective electric power consumer in a predetermined period, a consumed electric energy classification step of classifying total electric energy consumption by the electric power consumers in the period into m levels, a degree-of-load-contribution classification step of classifying degree of load contribution of the electric power consumers in consideration of at least load factors of the load factors which are ratios of average values of the consumed electric energy of the electric power consumers in the period to the maximum values of the consumed electric energy and uniformity coefficient which are ratios of sum totals of the maximum values of the consumed electric energy of the electric power consumers who belong to the same level of the consumed electric energy in the period into n levels, an electric power consumer classification step of dividing the respective electric power consumers into m×n number of classes based on the classification steps, and an outputting step of outputting a result obtained in the electric power consumer classification step to a display unit for displaying or a storage unit for storing the result.

Other objects and features of this invention will become apparent from the following description with reference to the accompanying drawings.

### BRIEF DESCRIPTION OF THE DRAWINGS

FIG. 1 is a diagram which explains an electric power consumer data analyzing method according to a first embodiment of the present invention,

FIGS. 2A to 2C are diagrams, according to the first embodiment of the present invention, which explain concrete displays of the electric power consumer value maps,

FIG. 3 is a diagram, according to the first embodiment of the present invention, which explains an example of pieces of information related to electric power consumers,

FIG. 4 is a flow chart, according to the first embodiment of the present invention, which explains the decision tree analysis process step,

FIGS. 5A and 5B are graphs, according to the first embodiment of the present invention, which explain a method to calculate a significant level in the decision tree analysis process step,

FIG. 6 is a diagram, according to the first embodiment of the present invention, which explains an example of a significant level table,

FIGS. 7A and 7B are diagrams, according to the first embodiment of the present invention, which explain an example of a formed decision tree,

FIGS. 8A and 8B are diagrams, according to the first embodiment of the present invention, which explain a concrete display example of an analysis result obtained by the data mining process step,

FIG. 9 is a diagram which explains a neural network analysis process step,

FIG. 10 is a diagram which explains an electric power consumer data analyzing method according to a second embodiment of the present invention,

FIGS. 11A and 11B are diagrams, according to the second embodiment of the present invention, which explain a concrete display of an electric power consumer value map, and

FIG. 12 is a diagram, according to the second embodiment of the present invention, which explains an example of a method of subdividing electric power consumers.

### DETAILED DESCRIPTIONS

When an electric power demand pattern is analyzed on the basis of the data on the electric energy consumption of electric power consumers to measure values of the electric power consumers in an electric power market when viewed from an electric power supplier, a method which uses statistics such as the maximum values and the average values of the consumed electric energy in a predetermined period is generally considered. In this method, since an electric power consumer who has a large consumed electric energy in the predetermined period pays high electric charges to the electric power supplier, the electric power consumer is of great value for the electric power supplier. However, in the electric power demand pattern, a time-series change in the consumed electric energy in the period is important. Even when the consumers have the maximum values of the consumed electric energy of which are equal to each other, the values of the electric power consumers change depending on consumed electric energy in other period of time. According to this method, since the electric power demand pattern cannot be recognized, it is difficult to appropriately recognize the values of the electric power consumers.

In contrast to this, according to the present invention, a total electric energy consumption is used as a standard used to measure a degree of contribution to earnings of electric charges of an electric power supplier. As a standard used to measure a degree of contribution to a reduction in facility cost of an electric power production facility of the electric power supplier, the degree of load contribution of the electric power consumers who consider at least load factors of the load factors which are ratios of average values of the consumed electric energy of the electric power consumers to the maximum values of the consumed electric energy and uniformity coefficients which are ratios of sum totals of the maximum values of the consumed electric energy of the electric power consumers who belong to the same level of the consumed electric energy in the period. The load factor is a factor to which the degree of contribution to the facility cost of the electric power consumer is reflected. The uniformity coefficient is a coefficient to which an influence on the maximum facility costs of the respective electric power consumers of the consumed electric energy of the electric power consumers having equal scale is reflected, and expresses weights of the respective electric power consumers in the total electric energy consumption. When at least the load factor of these is considered, the value of the electric power consumer can be recognized more appropriately than by a method which uses only the consumed electric energy. In addition, when the two parameters, i.e., the load factor and the uniformity coefficient are considered, the values of the electric power consumers can be more appropriately recognized.

Embodiments of the method according to the present invention will be described below with reference to the accompanying drawings.

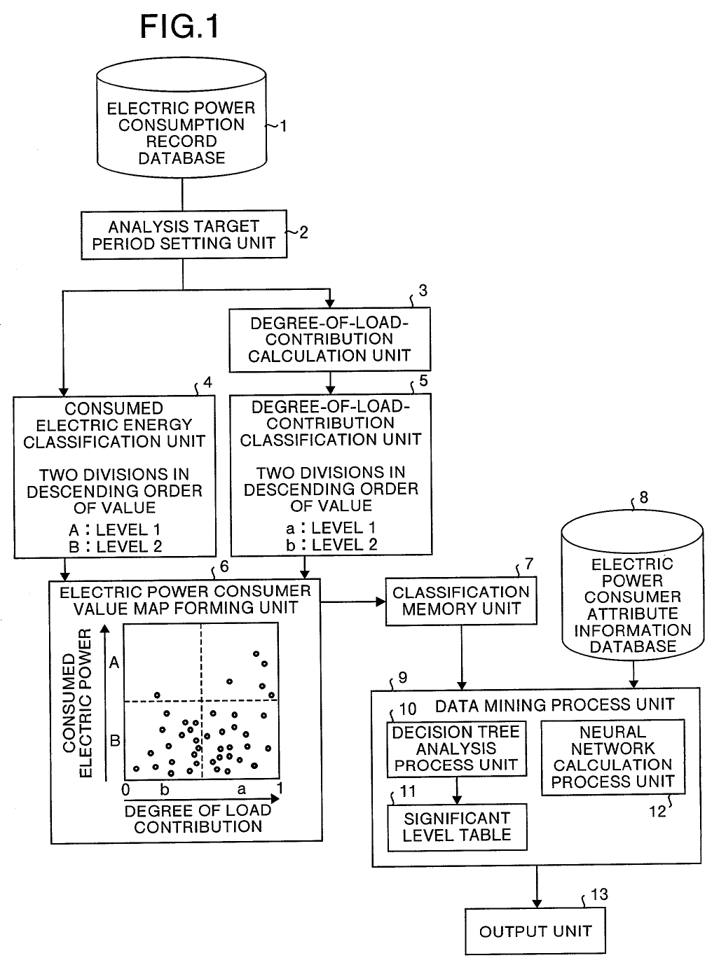

FIG. 1 is a diagram which explains an electric power consumer data analyzing method according to a first embodiment of the present invention. More specifically, FIG. 1 shows an entire configuration of an electric power consumer data analysis device and software and shows a flow of data with arrows.

In FIG. 1, reference numeral 1 denotes an electric power consumption record database. Reference numeral 2 denotes an analysis target period setting unit which sets a period of data extracted from the electric power consumption record database 1. Reference numeral 3 denotes a degree-of-load-contribution calculation unit which calculates the degree of load contribution of respective clients, i.e., the electric power consumers, from the extracted data. Reference numeral 4 denotes a consumed electric energy classification unit which classifies consumed electric energy into m (where m is a natural number) levels on the basis of a distribution of the consumed electric energy of the data. Reference numeral 5 denotes a degree-of-load-contribution classification unit which classifies the degree of load contribution into n (where n is a natural number) levels on the basis of the distribution of the degree of load contribution of the data. Reference numeral 6 denotes an electric power consumer value map forming unit which divides the respective electric power consumers into m×n classes on the basis of the classification of the consumed electric energy and the degree of load contribution and which displays the data of the electric power consumers who correspond to the m×n classes in a form of a map as an electric power consumer value map. Reference numeral 7 denotes a classification memory unit which records, in which classes the electric power consumers belong. Reference numeral 8 denotes an electric power consumer attribute information database which stores pieces of information related to the electric power consumers. Reference numeral 9 denotes a data mining process unit which decides, by which specific pieces of information the respective classes are being affected, by using the pieces of information related to the electric power consumers. The data mining process unit 9 is constituted by a decision tree process unit 10, a significant level table 11, and a neural network calculation process unit 12. Reference numeral 13 denotes an output unit which displays a result obtained by the decision in the data mining process unit 9.

The analysis target period setting unit 2, the degree-of-load-contribution calculation unit 3, the consumed electric energy classification unit 4, the degree-of-load-contribution classification unit 5, the decision tree process unit 10, and the neural network calculation process unit 12 are realized by software programs installed in a computer such as a workstation or a personal computer.

The classification memory unit 7 and the significant level table 11 are realized by electronic files in a computer such as a workstation or a personal computer.

The electric power consumer value map forming unit 6 is realized by a software program installed in a computer such as a workstation and a personal computer, a display device such as a cathode ray tube (CRT) monitor and a liquid crystal display and the like, which correspond to a display unit, a printer, or the like.

The output unit 13 is realized by a display device such as a CRT monitor and a liquid crystal display, a printer, or the like. The display device, the printer, or the like used in the electric power consumer value map forming unit 6 may also be used.

In the electric power consumption record database 1, with respect to a plurality of electric power consumers, consumed electric energy data at predetermined intervals such as 1 hour, 30 minutes, 15 minutes, or the like is time-serially stored for every electric power consumer.

In the analysis target period setting unit 2, according to an input from an operator, a period in which a data analysis is performed is set to be 1 day, 1 week, 1 month, 1 year, or the like, and the data on electric energy consumption in periods set for all the electric power consumers are extracted (the electric power consumer data collection step).

In the degree-of-load-contribution calculation unit 3, with respect to the consumed electric energy data in the extraction period, the degree of load contribution which expresses the degree of equality of the data on electric energy consumption is calculated.

The degree of load contribution is calculated using, e.g., the following equation (1).

degree of load contribution=α×(load factor)+(1 −α)×(uniformity coefficient) (1)

In equation (1), α is a coefficient which expresses a predetermined weight and which satisfies 0<α≦1. When α is 1, the degree of load contribution is equal to the load factor. When a is between 0 and 1, the degree of load contribution is a value which is set in consideration of the load factor and the uniformity coefficient.

The load factor is calculated using the following equations (2) or (3).

load factor=(average value of consumed electric energy in entire period)/(maximum value of consumed electric energy in entire period) (2),

load factor=(average value of consumed electric energy in entire period)/(average value of consumed electric energy at n times maximum in entire period) (3)

The uniformity coefficient is calculated using the following equations (6) or (7).

uniformity coefficient=(maximum value of total electric energy consumption in entire period)/(sum total of maximum values of consumed electric energy of respective electric power consumers in entire period) (4)

uniformity coefficient=(maximum value of total electric energy consumption at n time maximum in entire period)/(sum total of average values of consumed electric energy of electric power consumers at n times maximum in entire period) (5)

In equations (3) and (5), reference symbol n denotes an integer which is 2 or more. When n is 2, it is the average value of the consumed electric energy at time at which the consumed electric energy is maximum and at time at which a consumed electric energy is second maximum. In this manner, n averages are calculated in descending order of the consumed electric energy. For this reason, even when only one maximum value is considerably larger than values at the other times, characteristics of the electric power demand pattern can be more preferably grasped.

Thus, the load factor is maximum, i.e., 1 when the consumed electric energy at all the times are equal to each other. As the number of times at which the consumed electric energy is small increases, the load factor decreases. The uniformity coefficient is maximum, i.e., 1 when all the electric power consumers have the maximum values at the same time. As a variation of times at which the electric power consumers have the maximum values widely change, the uniformity coefficient decreases.

With respect to data in a period set by the analysis target period setting unit 2, all the electric power consumers are classified into m levels (two levels, i.e., A and B in FIG. 1) on the basis of a distribution of total electric energy consumption by the consumed electric energy classification unit 4 (the consumed electric energy classification step). As a method of the classification, for example, a method which calculates the maximum value and the minimum value of the data on electric energy consumption and which determines (m−1) threshold values such that values between the maximum value and the minimum value are equally classified by m is known. Similarly, the degree of load contributions are classified into n levels (two levels, i.e., a and b in FIG. 1) on the basis of the classification of the degree of load contribution by the degree-of-load-contribution classification unit 5 (the degree-of-load-contribution classification step).

m×n classes are formed by the consumed electric energy classification unit 4 and the degree-of-load-contribution classification unit 5.

The electric power consumer value map forming unit 6 divides the electric power consumers into m×n classes on the basis of the classification made by the consumed electric energy classification unit 4 and the degree-of-load-contribution classification unit 5 (the electric power consumer classification step). As the electric power consumer value map, data of the electric power consumers who correspond to the m×n classes are displayed in a form of a map (the electric power consumer value map forming step). For example, a two-dimensional graph in which the data on electric energy consumption and the degree of load contribution are laid off at the abscissa and the ordinate, is shown. In the graph, the data of the respective electric power consumers (the total electric energy consumption and the degree of load contribution in FIG. 1) are plotted on corresponding positions, and formed m×n classes are shown.

In the electric power consumer value map forming unit 6, to which class each electric power consumer belongs to can be decided. The result of this decision is stored in the classification memory unit 7.

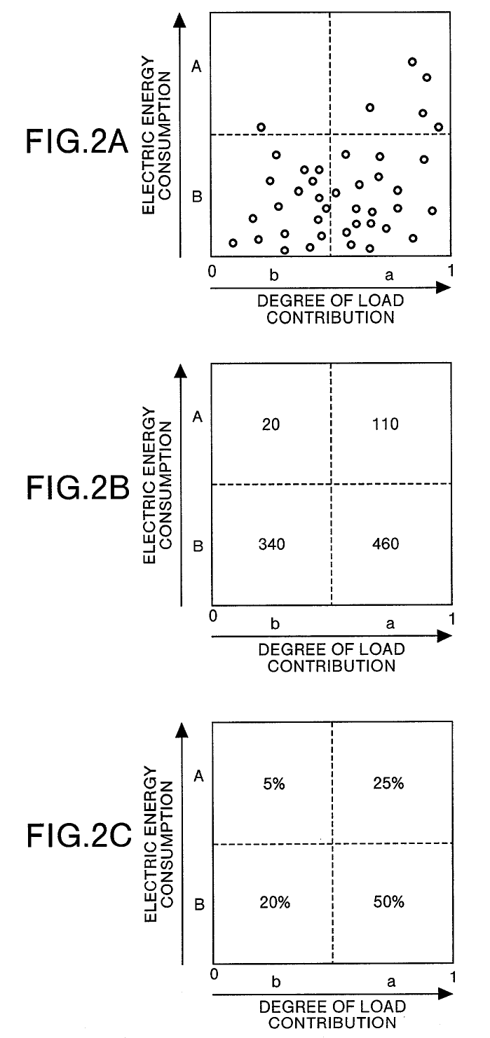

In FIGS. 2A to 2C, concrete display examples of the electric power consumer value maps are shown. FIG. 2A is the same as in FIG. 1, and shows a case when the total electric energy consumption and the degree of load contribution are plotted on the corresponding positions. FIG. 2B shows a case when the numbers of the electric power consumers who belong to the respective classes are displayed, and FIG. 2C shows a case when ratios of the numbers of the electric power consumers belonging to the classes to the total number of electric power consumers.

In FIGS. 2A to 2C, an electric power consumer who belongs to a class Aa in which the electric power consumer has a large consumed electric energy and a high degree of load contribution (close to 1) has a high degree of contribution to earnings of electric charges of an electric power supplier and a high degree of contribution to a reduction in the facility cost of the electric power production facility of the electric power supplier. For this reason, it can be determined that the electric power consumer is the most important electric power consumer who is the most valuable for the electric power supplier. In contrast to this, an electric power consumer who belongs to a class Bb in which the electric power consumer has a small consumed electric energy and a low degree of load contribution has a low degree of contribution to earnings of electric charges of an electric power supplier and a low degree of contribution to a reduction in facility cost of the electric power production facility of the electric power supplier. For this reason, it can be determined that the electric power consumer is the fourth important electric power consumer who is the least valuable for the electric power supplier. An electric power consumer who belongs to a class Ab in which an electric power consumer has a large consumed electric energy but a low degree of load contribution and an electric power consumer who belongs to a class Ba in which an electric power consumer has a small consumed electric energy but a high degree of load contribution are determined as follows. That is, when the degree of contribution to earnings of electric charges of an electric power supplier is considered as an important factor, it can be determined that the electric power consumer who belongs to the class Ab is the second important electric power consumer and that an electric power consumer who belongs to the class Ba is the third important electric power consumer. When the degree of contribution to facility cost of the electric power production facility of the electric power supplier is considered as an important factor, it can be determined that an electric power consumer who belongs to the class Ba is the second important electric power consumer and that an electric power consumer who belongs to the class Ab is the third important electric power consumer.

In this manner, according to the first embodiment, the electric power demand pattern is analyzed on the basis of the data on electric energy consumption in the past from the purchase data of the electric power consumers, and the values of the electric power consumers in the electric power market when viewed from an electric power supplier can be measured.

The consumers who are of high value for the electric power supplier must be enclosed by providing additional services to prevent them from changing the electric power supplier to another one. The contents of the additional services must be discriminated according to the measurement results of the above values. However, since the number of electric power consumers is very large, it is difficult to discriminate the contents of the additional services for the respective electric power consumers. For this reason, the classes of promising electric power consumers for the electric power supplier is recognized, and the contents of services can be discriminated according to the measurement results of the values of the respective electric power consumers and the respective electric power consumers.

The data mining process step will be explained below.

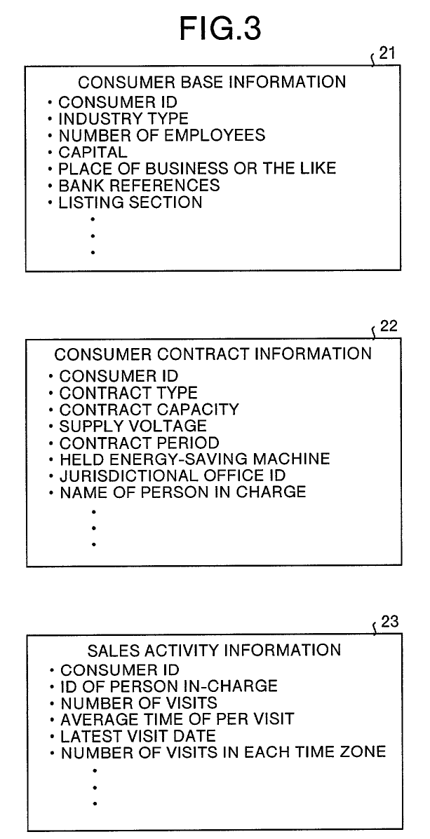

In the electric power consumer attribute information database 8, as pieces of information related to the respective electric power consumers, for example, electric power consumer attribute information constituted by electric power consumer basic information 21, electric power consumer contract information 22, and sales activity information 23 for the electric power consumers as shown in FIG. 3, is accumulated for every electric power consumer.

The data mining process unit 9 acquires pieces of information (electric power consumer attribute information) related to the respective electric power consumers from the electric power consumer attribute information database 8. On the basis of these pieces of information, the data mining process unit 9 decides, by which specific information, i.e., a specific item of the electric power consumer attribute information, each class is characterized (the data mining process step).

Operations of the decision tree process unit 10, the significant level table 11, and the neural network calculation process unit 12 which constitute the data mining process unit 9 will be described below.

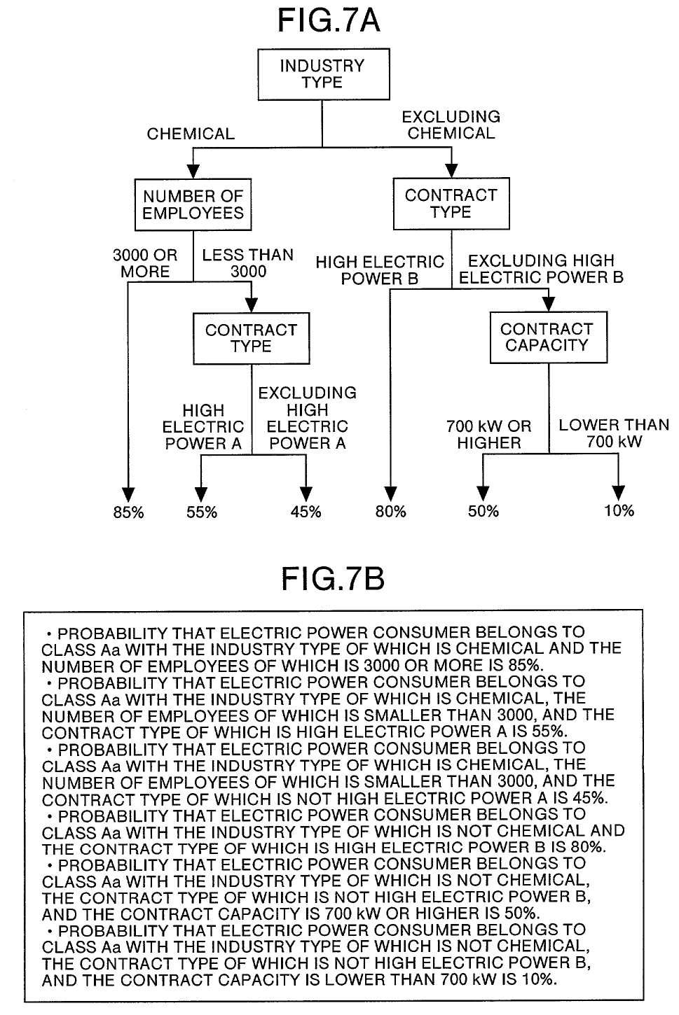

The decision tree analysis process step will be described below. The decision tree process unit 10 is operated to acquire belonging class information of the respective electric power consumers stored in the classification memory unit 7 and to load attribute information of the respective electric power consumers from the electric power consumer attribute information database 8, so that the decision tree analysis process which calculate the relationship between the belonging class information of the electric power consumers and the respective items (information) which constitute the electric power consumer attribute information for each class in the form of a tree shown in FIG. 7 is performed.

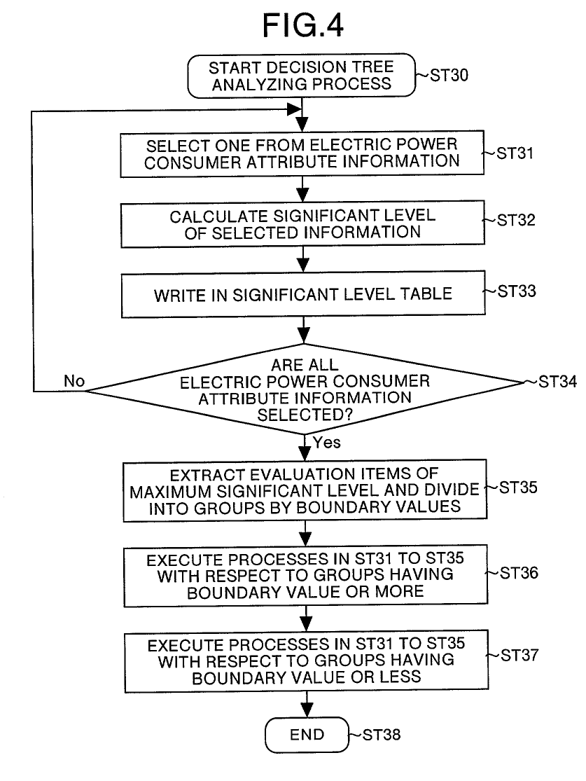

The decision tree analysis process step will be concretely explained below according to the flow chart in FIG. 4.

The decision tree analysis process is started at step ST30.

At step ST31, one item (item included in the consumer basic information, the consumer contract information, and the sales activity information in FIG. 3) is selected from the electric power consumer attribute information database 8.

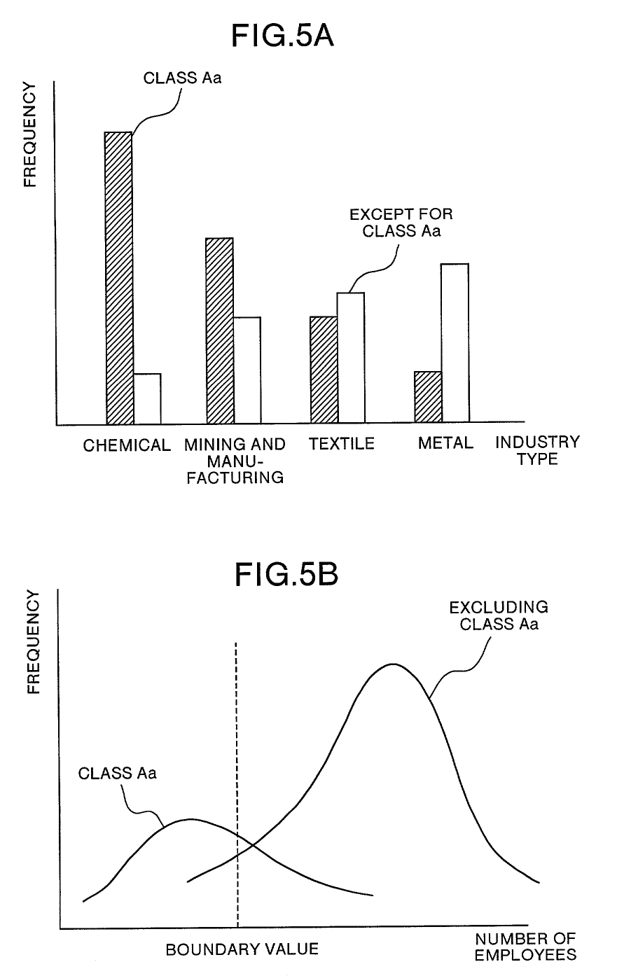

At step ST32, the significant level of the item selected in step ST31 is calculated for respective electric power consumer class. That is, with respect to the electric power consumer class Aa, for electric power consumers who belong to the class Aa and other consumers, the degree (significant levels) of strengthening of the relationships between the data contents (for example, as an industry type, the mining and manufacturing, the textile, the chemical, the agriculture, the forestry, or the like. As a listing section, those listed in the First Section of the Tokyo Stock Exchange, the NASDAQ Japan, unlisted, or the like) of the electric power consumer attribute information database 8 and the electric power consumer classes stored in the classification memory unit 7 are calculated. More specifically, as shown in FIGS. 5A and 5B, graphs are made by the relationships (distributions) between the electric power consumers who belong to the electric power consumer class Aa and the electric power consumers who belong to the other classes, and the selected electric power consumer attribute information. When the selected electric power consumer attribute information has discrete values (e.g., industry type), the graph shown in FIG. 5A is obtained. When the electric power consumer attribute information has continuous values (e.g., number of employees), the graph shown in FIG. 5B is obtained. On the basis of the formed graphs, a boundary value and a significant level of the electric power consumer attribute information are calculated. The same process as described above are performed for the other electric power consumer classes Ab, Ba, and Bb. A high significant level means that a corresponding item considerably affects the electric power consumer class.

A quantity of statistical information serving as a significant level uses a quantity of division information (entropy value) corresponding to electric power consumer attribute information which has a class as a decision reference variable (non-explained variable). The quantity of division information (entropy value) is calculated by decision algorithm C4.5 or CART (Classification and Regression Trees, one of binary tree analysis methods).

Decision algorithm C4.5 is described in, e.g., “Data Analysis by AI” written by J. R. Quinlan, supervised by Furukawa Kouichi, and issued by TOPPAN PRINTING CO., LTD., 1995. CART is described in, e.g., “Applied Binary Tree Analysis Method” written by Ootaki Atsushi, Horie Yuuji, D. Steinberg and issued by JUSE Press, Ltd., 1998. When a corresponding item of the electric power consumer attribute information data base 8 does not have category type variables, but has continuous values, boundary values are calculated as the variables such that the quantity of division information (entropy value) is minimum.

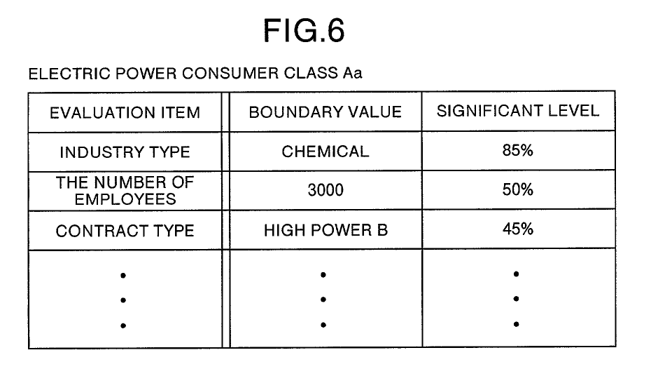

At step ST33, for every class, the significant levels of the respective electric power consumer attribute information calculated as described above are written in the significant level table 11. FIG. 6 shows an example of the significant level table. In FIG. 6 is shown an example of the significant level table.

At step ST34, for all the pieces of electric power consumer attribute information, the processes in step ST31 to step ST33 are repeated to calculate the significant levels and the boundary values.

At step ST35, the electric power consumer attribute information of the maximum significant level in the significant level table is extracted. More specifically, the electric power consumer attribute information which maximally affects a class is specified. In the example in FIG. 6, the significant level of the industry type has the maximum value, i.e., 85%. For this reason, it means that 85% of the electric power consumers with the industry type of which are chemical belong to the electric power consumer class Aa. It is understood that the industry type maximally affects the electric power consumer class. By the boundary values obtained in step ST32, the electric power consumers are divided into two groups.

At steps ST36 and ST37, for the groups of the divided electric power consumers, the same processes as those in step ST31 to step ST35 are sequentially repeated to more finely classify into groups, thereby to form a tree-like decision tree as shown in FIG. 7A. As compositional expressions of the decision tree, analysis result messages shown in FIG. 7B are formed.

The decision tree analysis process is completed at step ST38.

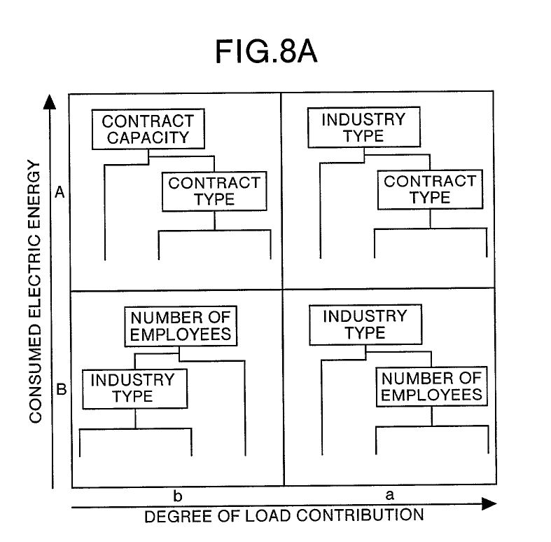

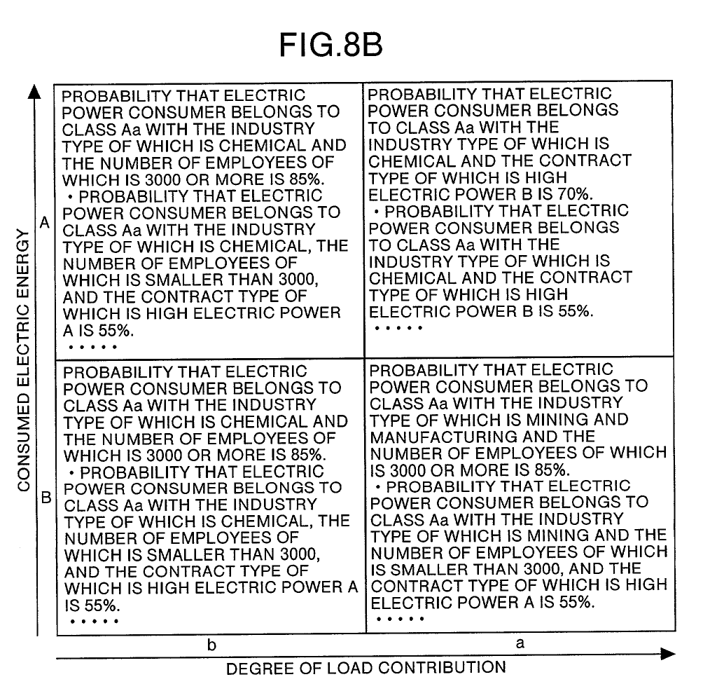

FIGS. 7A and 7B which are the analysis results are displayed and output by an output unit 14. As a concrete display example, specific electric power consumer attribute information is displayed at a position of a corresponding class in, e.g., the consumer value map. For example, a method which displays a decision tree obtained for respective electric power consumer class as shown in FIG. 8A and a method which displays a composition expression which corresponds to a decision tree obtained for respective electric power consumer class as shown in FIG. 8B are used.

In this manner, electric power consumer attribute information which maximally affects an electric power consumer class determined on the basis of the data on electric energy consumption can be specified and displayed.

Since the above process is performed for each of the electric power consumer classes Aa, Ab, Ba, and Bb, characterized electric power consumer information generally change depending on the electric power consumer classes.

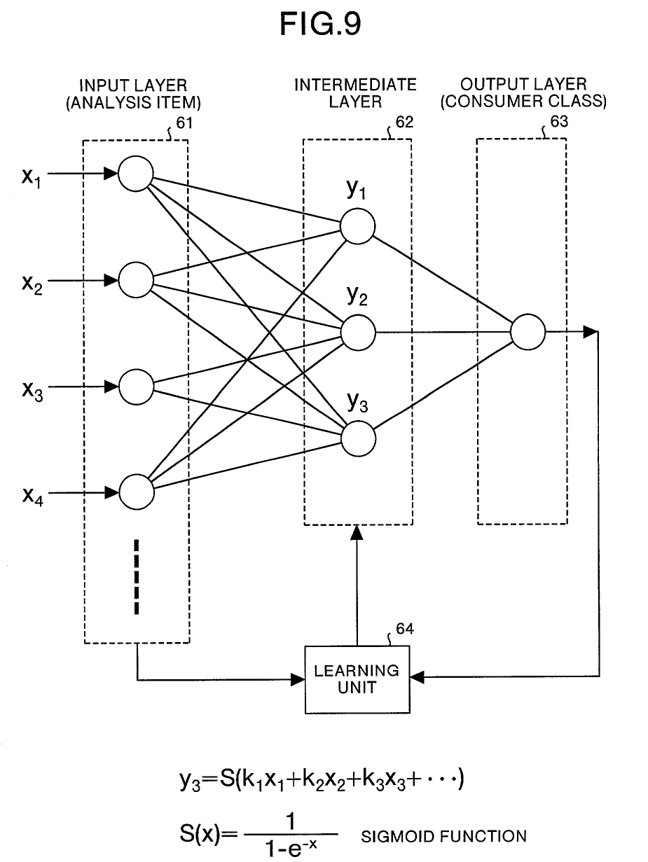

The neural network analysis process step in the neural network calculation process unit 12 will be explained below with reference to FIG. 9. In FIG. 9, reference numeral 61 denotes an input layer, 62 denotes an intermediate layer, 63 denotes an output layer, and 64 denotes a learning unit.

The neural network calculation process unit 12, as is generally known, is constituted by the input layer 61, the intermediate layer 62, the output layer 63, and the learning unit 64.

The electric power consumer attribute information of the respective electric power consumers who belong to the respective electric power consumer classes (e.g., As in Aa of FIG. 1), i.e., data contents x₁, x₂, x₃ . . . of the respective items of the electric power consumer attribute information database 8 are input from the input layer 61. A belonging class (e.g., Aa, Ab, or the like in FIG. 1) of the corresponding electric power consumer is output from the output layer 63. Respective values y₁, y₂, y₃, of the intermediate layer 62 are expressed by Sigmoid function S(x).

y₁=S(k₁₁x₁+k₁₂x₂+ . . . )

y₂=S(k₂₁x₁+k₂₂x₂+ . . . )

y₃=S(k₃₁x₁+k₃₂x₂+ . . . )

S(x)=1/(1−e^{-x})

where K₁₁, k₁₂, k₁₃, . . . , k₂₁, k₂₂, k₂₃, . . . , k₃₁, k₃₂, k₃₃, . . . are weight coefficients.

When the electric power consumer attribute information x₁, x₂, x₃, . . . of the electric power consumers are input to the input layer 61, the learning unit 64 learns and determines the weight coefficients k₁₁, k₁₂, k₃₁, . . . , k₂₁, k₂₂, k₂₃, . . . , k₃₁, k₃₂, k₃₃ of the respective intermediate layer 62 such that the electric power consumer class output from the output layer 63 coincides with the class of the corresponding electric power consumer stored in the classification memory unit 7 in advance.

At the point when the weight coefficients of the intermediate layer 62 are determined almost correctly, the relationships between respective items which constitute the input layer 61 and the respective electric power consumer classes which constitute the output layer 63 become clear. In other words, a manner that the respective items contribute to the electric power consumer classes is quantitatively grasped.

The intermediate layer is constituted by a plurality of stages, so that the neural network can also be constituted.

The output unit 13 displays and outputs a list of the weight coefficients of the respective intermediate layer for each electric power consumer class obtained by the neural network calculation process unit 12 to respective electric power consumer class.

In the data mining process unit 9, the decision tree analysis process step of the decision tree process unit 10 and the neural network analysis process step of the neural network calculation process unit 12 are selectively performed by the operator in advance. As a matter of course, both the decision tree analysis process step and the neural network analysis process step may be performed. The selection of the decision tree process step and the neural network analysis process step is dependent on the consumed electric energy and the electric power consumer attribute information. It is selected by comparison such that a better result can be obtained.

As described above, according to the first embodiment, the data on electric energy consumption by the respective electric power consumer are collected in a predetermined period, and the degree of contribution to the earnings of the electric charges of the electric power supplier are dependent on the consumed electric energy in the predetermined period, and the consumed electric energy of the electric power consumers are classified into m levels. The degree of the contribution to facility cost of the electric power production facility of the electric power supplier is dependent on the degree of load contribution which is a ratio of the average value of the consumed electric energy to the maximum value of the consumed electric energy in the period. The degree of load contribution of the respective electric power consumers are classified into n levels. On the basis of these classifications, the electric power consumers are divided into m×n classes. For this reason, an effect described in below described (1) is achieved.

(1) An electric power demand pattern is analyzed on the basis of the data on electric energy consumption by the electric power consumers, and the values of the electric power consumers in the electric power market when viewed from the electric power supplier can be measured. As a result, an electric power consumer group which is important for the electric power supplier can be measured and analyzed at high accuracy.

Moreover, as the electric power consumer value map, the data of the electric power consumers who correspond to the m×n respective classes are displayed in a form of a map. For this reason, an effect described in below described (2) is achieved.

(2) Since the data of the electric power consumers corresponding to the m×n classes are displayed in a form of a map, the data can be easily visually understood.

Moreover, the respective electric power consumers are divided into the m×n classes as described above, and pieces of information related to the electric power consumers are acquired. On the basis of these pieces of information, the relationships between the respective classes and the respective information are analyzed (the data mining process step), and result of analysis is displayed. For this reason, effects described in below described (3) to (6) are a chieved.

(3) A promising electric power consumer group for the electric power supplier is grasped, and the following decision-makings can be effectively performed on the basis of the grasp and the measured analysis result in (1). For example, when a result that chemical is an industry type which maximally affects the most promising electric power consumer class Aa for the electric power supplier is obtained, sales activity which depend on a load (e.g., an arc furnace) required for chemical industry can be performed. For example, the contents of a proposal of facility to improve a power factor can be distributed as sales activity support references to persons in charge of sales.

(4) With respect to respective class, it is possible to analyze at high accuracy, which specific information related to an electric power consumer characterizes the electric power consumer who belongs to the corresponding class, i.e., the data on electric energy consumption. Thus, an item which maximally affects respective class can be specified. As a result, a measure such as a sales activity which depends on each class can be performed. For example, when an item which maximally affects each class is chemical as an industry type, a sales activity which depends on a load (e.g., an arc furnace or the like) required for a chemical industry, e.g., the contents of a proposal of a facility to improve a power factor can be distributed as sales activity support reference to persons in charge of sales.

(5) When the contents of information which characterizes an electric power consumer who belong to respective class are analyzed, the result of marketing activity such as providing of service is analyzed, a decision-making can be accurately performed to the following measurement. Sales activity information is also held as electric power consumer attribute information for each electric power consumer. However, by deciding, to which electric power consumer class the corresponding electric power consumer belongs, positioning of the electric power consumer of all the electric power consumers can be grasped. For example, the following measure is effective. That is, when the number of visits of a person in charge of sales to the electric power consumer who is desirable for the electric power supplier is small, the number of visits to another electric power consumer to which the person in charge of sales makes a visit is reduced, and the number of visits to the corresponding electric power consumer is increased.

(6) By using the analysis result obtained in the data mining process step, with respect to, e.g., a new electric power consumer for whom data on electric energy consumption is not available, a class to which the electric power consumer belongs can be estimated on the basis of pieces of information (for example, the electric power consumer basic information 21 in FIG. 3) related to the electric power consumer.

The first embodiment describes the case when the consumer value maps as shown in FIGS. 2A to 2C are formed and displayed. However, without forming the consumer value map, information of respective classes (more specifically, for example, the ranges of a total electric energy consumption and the degree of load contribution and the like), data (more specifically, for example, the number of electric power consumers who belong to the classes, ID numbers, and the like) of the electric power consumers who belong to the respective classes, and the like may be arranged and displayed as the results obtained in the electric power consumer classification step, together with the analysis results obtained in the data mining process step 1n addition, without displaying, the data and the like can be stored in a storage unit such as the classification memory unit 7, so that a user may extract the stored contents as needed.

The first embodiment describes the case in which the data mining process unit 9 has both the decision tree process unit 10 and the neural network calculation process unit 12. However, the data mining process unit 9 may have only one of these units. In addition, when the data mining process unit 9 has both the units, which process to be used may be set in advance.

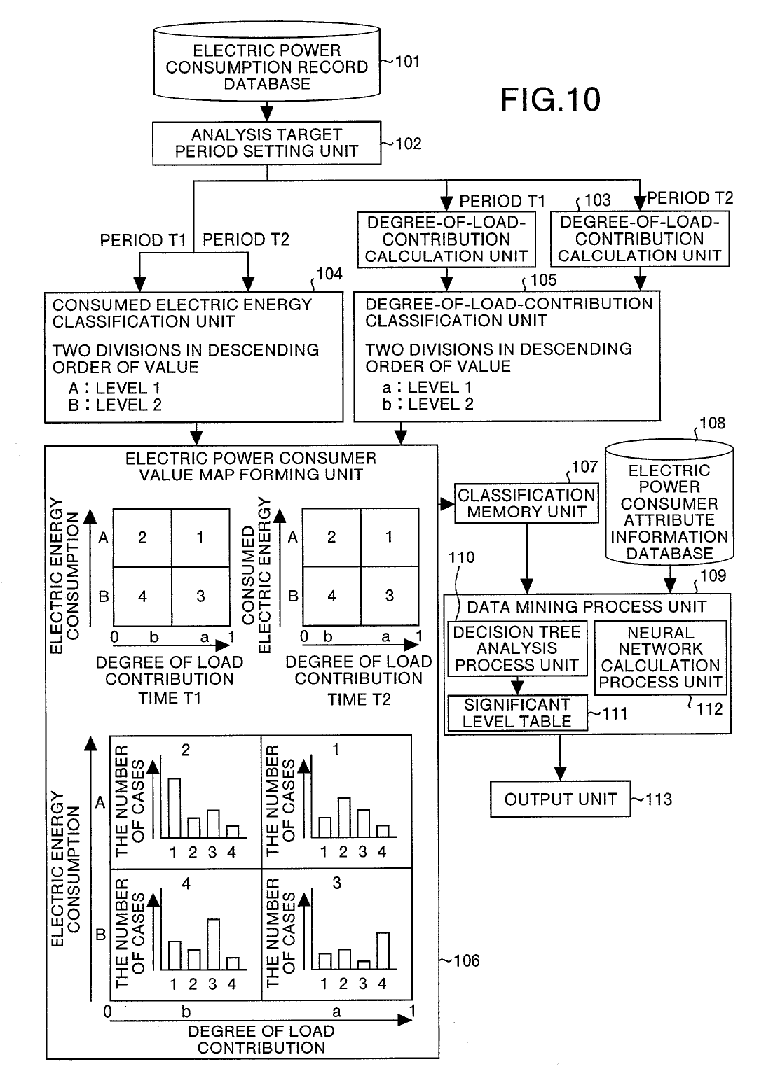

FIG. 10 is a diagram which explains the second embodiment of the electric power consumer data analysis method according to the present invention. More specifically, FIG. 10 shows an entire configuration of the electric power consumer data analysis device and software and shows a flow of data with arrows.

In FIG. 10, reference numeral 101 denotes an electric power consumption record database. Reference numeral 102 denotes an analysis target period setting unit which sets two periods T1 (first half period) and T2 (second half period) of data extracted from the electric power consumption record database 101. Reference numeral 103 denotes a degree-of-load-contribution calculation unit which calculates the degree of load contribution of respective clients, i.e., the electric power consumers from the extracted data in respect to both periods of the first half period and the second half period. Reference numeral 104 denotes a consumed electric energy classification unit which classifies the consumed electric energy into m levels on the basis of a distribution of the consumed electric energy of the data with respect to the first half period and the second half period. Reference numeral 105 denotes a degree-of-load-contribution classification unit which classifies the degree of load contribution into n levels on the basis of the distribution of the degree of load contribution of the data in both the periods of the first half period and the second half period.

Reference numeral 106 denotes an electric power consumer value map forming unit which divides the respective electric power consumers into m×n classes in both the periods of the first half period and the second half period, which displays the data of the electric power consumers who correspond to the m×n classes in a form of a map as an electric power consumer value map, and which compares the electric power consumers in the first half period (period T1) and the second half period (period T2) with each other to categorize the electric power consumer classes to which electric power consumers who belong to electric power consumer classes in the period T2 belong in the period T1 and to display the electric power consumer classes.

Reference numeral 107 denotes a classification memory unit which records, in which classified classes the electric power consumers belong. Reference numeral 108 denotes an electric power consumer attribute information database which stores pieces of information related to the electric power consumers. Reference numeral 109 denotes a data mining process unit which decides, by which specific pieces of information the respective classes are being affected, by using the pieces of information related to the electric power consumers. The data mining process unit 109 is constituted by a decision tree process unit 110, a significant level table 111, and a neural network calculation process unit 112.

Reference numeral 113 denotes an output unit which displays a result obtained by the decision in the data mining process unit 109.

The analysis target period setting unit 102, the degree-of-load-contribution calculation unit 103, the consumed electric energy classification unit 104, the degree-of-load-contribution classification unit 105, the decision tree process unit 110, and the neural network calculation process unit 112 are realized by software programs installed in a computer such as a workstation or a personal computer.

The classification memory unit 107 and the significant level table 111 are realized by electronic files in a computer such as a workstation or a personal computer.

The electric power consumer value map forming unit 106 is realized by a software program installed in a computer such as a workstation and a personal computer, a display device such as a CRT (Cathode Ray Tube) monitor and a liquid crystal display and the like which correspond to a display unit, a printer, or the like.

The output unit 113 is realized by a display device such as a CRT (Cathode Ray Tube) monitor and a liquid crystal display, a printer, or the like. The display device, the printer, or the like used in the electric power consumer value map forming unit 106 may also be used.

In the electric power consumption record database 101, with respect to a plurality of electric power consumers, consumed electric energy data at predetermined intervals such as 1 hour, 30 minutes, 15 minutes, or the like is time-serially stored for every electric power consumer.

In the analysis target period setting unit 102, according to an input from an operator, two periods (T1 and T2) in order to compare, are set to be 1 day, 1 week, 1 month, 1 year, or the like, and the data on electric energy consumption in periods T1 and T2 set for all the electric power consumers are extracted (the electric power consumer data collection step).

In the degree-of-load-contribution calculation unit 103, with respect to the consumed electric energy data in the extraction periods T1 and T2, the degrees of load contribution which express the degrees of equality of the data on electric energy consumption are calculated. The degree of load contribution is calculated in the same manner as in the first embodiment.

In the consumed electric energy classification unit 104, with respect to the data in the periods T1 and T2 set in the analysis target period setting unit 102, all the electric power consumers are classified into m levels (two levels, i.e., A and B in FIG. 10) on the basis of the distribution of total electric energy consumption (the consumed electric energy classification step). A classification method is the same as that in the first embodiment. Similarly, the degree of load contribution are also classified into n levels (two levels, i.e., a and b in FIG. 10) by the degree-of-load-contribution classification unit 105 on the basis of the classification of the degree of load contribution (the degree-of-load-contribution classification step).

For the periods T1 and T2 set by the analysis target period setting unit 102, m×n classes are formed by the consumed electric energy classification unit 104 and the degree-of-load-contribution classification unit 105.

The electric power consumer value map forming unit 106 divides the electric power consumers into the m×n classes for the respective periods T1 and T2 set by the analysis target period setting unit 102 on the basis of the classification by the consumed electric energy classification unit 4 and the degree-of-load-contribution classification unit 5 (the electric power consumer classification step). As the electric power consumer value map, data of the electric power consumers who correspond to the m×n classes are displayed in form of a map (the electric power consumer value map forming step). As a concrete display example, for example, the maps shown in FIGS. 2A to 2C can be cited.

In the electric power consumer value map forming unit 106, to which class each electric power consumer belongs to can be decided.

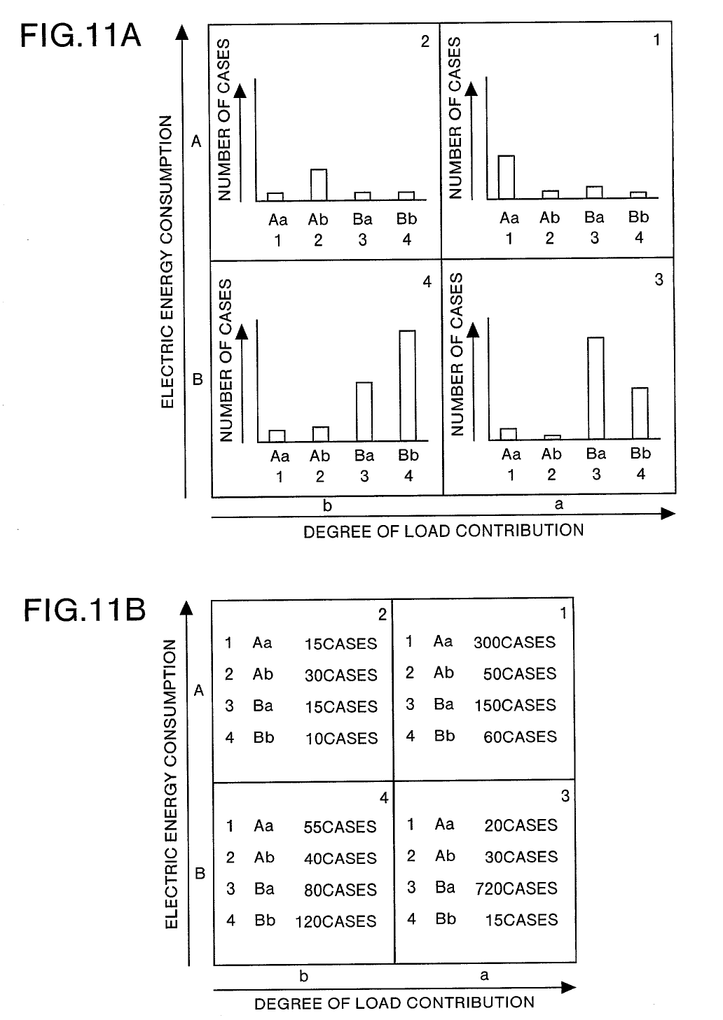

After the electric power consumer classes in the periods T1 and T2 are decided, a change of a configuration ratio of the number of electric power consumers between the first half period (period T1) and the number of electric power consumers in the second half period (period T2) is displayed. As an example, a specific electric power consumer class to which electric power consumers who belong to the electric power consumer classes in the period T2 belong in the period T1 is decided. As shown in FIG. 11A, as in the same display method in the electric power consumer class display, a graph categorized by the numbers of electric power consumers classified into the electric power consumer classes in the period T1 is displayed at a position which corresponds to the electric power consumer classes in the period T2 (the classification display step by movement of the electric power consumer classes). As shown in FIG. 11B, as in the display method in the electric power consumer class display, a table categorized by the number of the electric power consumers classified into electric power consumer classes in the period T1 is displayed at a position which corresponds to the electric power consumer classes in the period T2 (the classification display step by movement of the electric power consumer classes).

By the classification performed by the movement of the electric power consumer classes, as described above, the electric power consumer classes can be subdivided according to which specific electric power consumer classes the electric power consumers belong in the periods T1 and T2.

In the second embodiment, a class As in which an electric power consumer has a large consumed electric energy and a high degree of load contribution (close to 1) is set to be class 1, a class Ab in which an electric power consumer has a large consumed electric energy but a low degree of load contribution is set to be class 2, a class Ba in which an electric power consumer has a small consumed electric energy but a high degree of load contribution is set to be class 3, and a class Bb in which an electric power consumer has a small consumed electric energy and a low degree of load contribution is set to be class 4, and these are displayed in positions of respective classes in FIGS. 11A and 11b. Numbers 1 to 4 in the graphs in FIGS. 11A and 11B indicate class numbers, respectively.

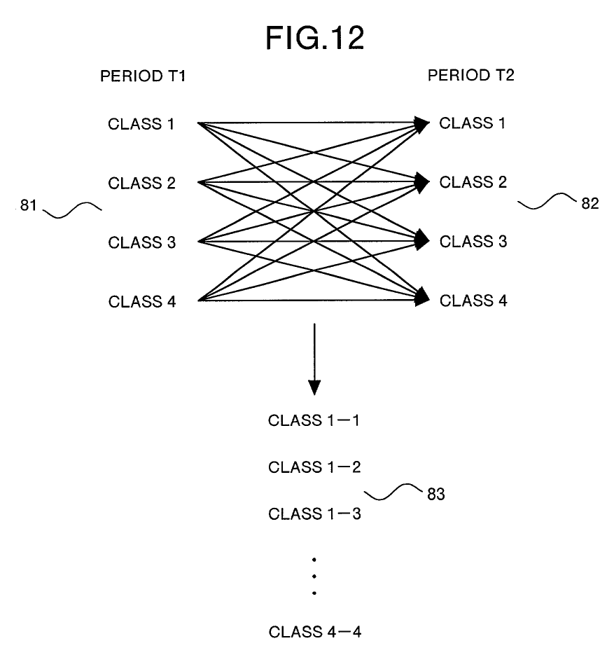

FIG. 12 is a diagram which explains an example of a method to subdivide electric power consumer classes. As shown in FIG. 12, for example, an electric power consumer who belongs to class 1 in the periods T1 and T2 belongs to class 1-1, and an electric power consumer who belongs to class 1 in the period T1 and which moves to class 2 in the period T2 belongs to electric power consumer class 1-2, so that electric power consumer classes 81 in the period T1 and electric power consumer classes 82 in the period T2 are subdivided into smaller electric power consumer classes 83 which include the contents of changes of the statuses of the electric power consumers.

In the electric power consumer value map forming unit 106, the respective electric power consumers are subdivided as shown in FIG. 12, and a class to which each electric power consumer belongs can be decided. The result of decision is stored in the classification memory unit 107.

The data mining process step will be explained below.

In the electric power consumer attribute information database 108, as shown in FIG. 3, electric power consumer attribute contract information constituted by electric power consumer basic information 21, electric power consumer contract information 22, and sales activity information 23 for the electric power consumers is accumulated for every electric power consumer.

The data mining process unit 109 uses the electric power consumer value map forming unit 106 to decide, by which specific item (information) which is accumulated in the electric power consumer attribute information database 108 as pieces of information related to the specific electric power consumers the respective classes which are subdivided and which include the contents of the changes of the statuses of the electric power consumers like the electric power consumer classes 83 in FIG. 12 is characterized (the data mining process step).

The operations of the decision tree process unit 110, the significant level table 111, and the neural network calculation process unit 112 which constitute the data mining process unit 109 are the same as the operations of the decision tree process unit 10, the significant level table 11, and the neural network calculation process unit 12 which constitute the data mining process unit in the first embodiment.

In the data mining process unit 109, which of the decision tree analysis process of the decision tree process unit 110 and the neural network analysis process step of the neural network calculation process unit 112 to be used can be selected in advance by the operator as in the first embodiment. As a matter of course, both the decision tree analysis process step and the neural network analysis process step may be performed.

The output unit 113 displays and outputs at least one of the results obtained by the significant level table 111 in the decision tree analysis process and a list of respective weight coefficients of the intermediate layer obtained by the neural network calculation process unit 112.

As described above, according to the second embodiment, the data on the electric energy consumption by the electric power consumers are collected in at least two periods, i.e., the first half period and the second half period, and total electric energy and the degrees of load contribution are classified for the respective periods into m and n. The electric power consumers are divided into the m×n classes in the respective periods, the pieces of information of the electric power consumers who correspond to the m×n classes in the respective periods are displayed in a form of a map, and a change of the configuration ratio of the number of electric power consumers in the first half period to the number of electric power consumers in the second half period is displayed. For this reason, in addition to the effects in (1) and (2) explained in the first embodiment, the manner of the change in status of the electric power consumer can be known. Therefore, there is obtained an effect that a more appropriate countermeasure can be advantageously made. For example, on the basis of the degree and pattern of the change in status of an electric power consumer, the effect of marketing activity such as service providing is analyzed, and a decision-making can be more accurately performed to the following measurement.

With respect to the subdivided classes which include the contents of the changes in status of the electric power consumers, the relationships between the respective classes and the pieces of information related to the electric power consumers are analyzed (the data mining process step), and obtained analysis results are displayed. For this reason, the following effects in (7) and (8) are achieved.

(7) With respect to the subdivided classes including the contents of the changes in status of the electric power consumers, it is possible to analyze, by which specific information which is related to the electric power consumers, the electric power consumers who belong to the classes, i.e., transition of the data on the electric energy consumption are characterized, and to specify an item (information) which maximally affects respective class. As a result, a more exact countermeasure (e.g., sales activity or the like) according to each class, i.e., depending on the changes in status of the electric power consumers, or depending on the transition of the data on electric energy consumption can be performed. For example, for an electric power consumer changed from the electric power consumer class Aa to the electric power consumer class Ba, the consumed electric energy decreases without a large change in the degree of load contribution. For this reason, with reference to sales activity information to the corresponding electric power consumer, an analysis is performed to check whether the number of visits to the corresponding electric power consumer is larger than the numbers of visits to other electric power consumers. The change in consumed electric energy can be considered as that the electric power consumer introduces or abandons some load facility. For this reason, it can be considered that a person in charge of sales for the corresponding electric power consumer is instructed to obtain information related to the load facility.

(8) By analyzing the contents of information which characterizes the electric power consumers who belong to the classes, the effect of marketing activity such as service providing to the transition of the data on electric energy consumption is analyzed, and a decision-making can be more accurately performed to the following measurement. For example, with respect to an electric power consumer changed from the electric power consumer class Ab to the electric power consumer class Aa, when the degree of load contribution is without a large change in the consumed electric energy, and when the chemical is an industry type serving as information which maximally characterizes the electric power consumers, sales activity for the chemical is performed as sales promotion activity of an ice thermal storage system which changes a peak demand from the daytime to the nighttime, and the effect of the sales activity appears to increase the degree of load contribution. In this case, a decision-making is effectively performed such that the person in charge of sales is shifted to the sales activity to another industry type where the degree of load contribution is not improved.

The periods T1 and T2, i.e., the first half period and the second half period, maybe continued such that January to June and July to December in a year are set, or they may be separated from each other such that January in a year and January in the next year are set. In addition, the periods may overlap such that January 1 to May 31 and May 1 to June 31 are set.

The second embodiment describes a case in which the data on electric energy consumption by the electric power consumers are separately collected in the two periods, i.e., the former period and the second half period. However, the data may be separately collected in three or more periods, i.e., the first half period, the middle period, and the latter period.

The second embodiment describes a case in which the data of the electric power consumers displayed as an electric power consumer value map includes total electric energy consumption and the degree of load contribution. However, it is not limited to this case. For example, the number of the electric power consumers who belong to a corresponding class, a rate of the number of the electric power consumers to the number of all the electric power consumers, the analysis result obtained by the data mining process unit, or the like may be used as in the first embodiment.

The second embodiment describes a case in which the electric power consumer value map as shown in FIG. 11 is formed and displayed. However, without forming the electric power consumer value map, and, as a result obtained in the electric power consumer classification step, the information (more specifically, for example, the change and the like of the ranges of a total electric energy consumption and the degree of load contribution) of the respective classes, data (more specifically, for example, the numbers of electric power consumers who belong to the classes, ID numbers, and the like) of the electric power consumer who belongs to the respective classes, and the like may be arranged and displayed together with the analysis result obtained by the data mining process step.

In addition, without displaying, it may be stored in the storage unit such as the classification memory unit 7 for example, and the storage contents may be extracted by the user as needed.

The second embodiment describes a case in which the data mining process unit 109 has both the decision tree process unit 110 and the neural network calculation process unit 112. The data mining process unit 109 may have one of the two as in the first embodiment. When it has both the decision tree process unit 110 and the neural network calculation process unit 112, one of these processes is set in advance.

In the first and second embodiments, in the electric power consumer data collection step, the data on the electric energy consumption by the electric power consumers are collected in a predetermined period regardless of the daytime and the nighttime was described. However, the data on the electric energy consumption by the electric power consumers maybe separately collected in the daytime and the nighttime. This case will be explained below as the third embodiment of the electric power consumer data analysis method according to the present invention.

More specifically, in the electric power consumer data collection step, the data on electric energy consumption by the electric power consumers in the daytime and nighttime are collected in a predetermined period. In the consumed electric energy classification step and the degree-of-load-contribution step, the total electric energy and the degree of load contribution are classified in respect to the daytime and the nighttime. In the electric power consumer classification step, the respective electric power consumers are divided into m×n classes in respect to the daytime and the nighttime. In the electric power consumer value map forming step, pieces of information of the electric power consumers who correspond to the m×n classes are displayed in a form of a map in respect to the daytime and the nighttime.

In the data mining process step, the relationships between the respective classes and the respective information related to the electric power consumers are analyzed in the daytime and the nighttime, respectively. In the display step, the result of the analysis are displayed in respect to the daytime and the nighttime.

The consumed electric energy of each electric power consumer in the daytime and the nighttime are considerably different from each other. Therefore, since the data on electric energy consumption are separately collected and analyzed in the daytime and the nighttime, so that the values of the electric power consumers in the electric power market when viewed from an electric power supplier can be more accurately measured.

As time settings of the daytime and the nighttime, the daytime and the nighttime are appropriately and freely set according to situations. For example, 8 o'clock a.m. and 10 o'clock p.m. are set as boundaries, a period from 8 o'clock a.m. to 10 o'clock p.m. is set as the daytime, and a period from 10 o'clock p.m. to 8 o'clock of the next morning is set as nighttime. As a matter of course, a certain time may not belong to either of the daytime or the nighttime such that a period from 8 o'clock a.m. to 5 o'clock p.m. is set as the daytime, and a period from 7 o'clock p.m. to 6 o'clock of the next morning is set as the nighttime. A certain time may overlap the daytime and the nighttime such that a period from 6 o'clock a.m. to 7 o'clock p.m. is set as the daytime, and a period from 5 o'clock p.m. to 7 o'clock of the next morning is set as the nighttime.

The third embodiment describes a case in which the data on electric energy consumption by the respective electric power consumer in, both, the daytime and the nighttime are collected and analyzed. However, it is not limited to this case. Either the data on electric energy consumption in the daytime or the nighttime may be collected and analyzed.

As has been described above, according to the present invention, the electric power consumer data analyzing method comprises, the electric power consumer data collection step which, in the electric power market in which a plurality of electric power consumers purchase electric power from an electric power supplier, collects the data on electric energy consumption by each electric power consumer in a predetermined period, the consumed electric energy classification step which classifies total electric energy consumption by the electric power consumers in the period into m levels, the degree-of-load-contribution classification step which classifies the degrees of load contribution of the electric power consumers in consideration of at least load factors of the load factors which are ratios of average values of the consumed electric energy of the electric power consumers in the period to the maximum values of the consumed electric energy and uniformity coefficient which are ratios of sum totals of the maximum values of the consumed electric energy of the electric power consumers who belong to the same level of the consumed electric energy in the period into n levels, the electric power consumer classification step which divides the respective electric power consumers into m×n classes on the basis of the two classification steps, and the step which outputs a result obtained in the electric power consumer classification step to a display unit or a storage unit. For this reason, the electric power demand pattern is analyzed on the basis of the data on electric energy consumption by the electric power consumers, so that the values of the electric power consumers in the electric power market when viewed from an electric power supplier can be measured.

Since the degree of load contribution can be calculated by equation (1), the electric power demand pattern is analyzed on the basis of the data on electric energy consumption by the electric power consumers, so that the values of the electric power consumers in the electric power market when viewed from an electric power supplier can be measured.

The method comprises the electric power consumer value map forming step which expresses the data of electric power consumers who correspond to the m×n classes in the form of a map. For this reason, the data can be visually understood.

The data on electric energy consumption by the electric power consumers are separately collected in at least two periods, i.e., the first half period and the second half period in the electric power consumer data collection step, the total electric energy consumption and the degree of load contribution are classified by m and n in the respective periods in the consumed electric energy classification step and the degree-of-load-contribution classification step, and the respective electric power consumers are classified into m×n classes in the respective periods in the electric power consumer classification step. For this reason, the manner of a change in status of the electric power consumer can be known. As a result, changes in the load of the electric power consumed by the electric power consumers can be investigated by sales activity, so that a proper countermeasure can be performed.

The method comprises the data mining process step which acquires pieces of information related to the respective electric power consumers and which analyzes the relationships of the classes and the respective information on the basis of the pieces of information. For this reason, with respect to the classes, it is possible to analyze at high accuracy, by which specific information which is related to the electric power consumers, the electric power consumers who belong to the classes, i.e., the data on electric energy consumption are characterized, and an item which maximally affects each class can be specified. Therefore, a countermeasure according to the respective class can be performed. In addition, by using the result of analysis obtained in the data mining process step, with respect to an electric power consumer for whom data on electric energy consumption is not available, a class to which the electric power consumer belongs can be estimated on the basis of pieces of information related to the electric power consumer.

The data mining process step has the decision tree analysis process step which calculates the relationships between the classes and the data contents of the pieces of information in a form of a tree. For this reason, the relationships between the respective classes and the respective information can be analyzed.

The data mining process step has the neural network process step which has the data contents of the pieces of information of the electric power consumers who belong to the classes as an input layer, the classes to which the electric power consumers belong as an output layer, and an intermediate layer between the input layer and the output layer, and the network leaning process step which inputs the data contents of the pieces of information to the input layer and which calculates the weight coefficient of the intermediate layer on the basis of the classes which are output from the output layer and to which the electric power consumers belong. For this reason, the relationships between the classes and the pieces of information can be analyzed.

The results of the electric energy consumption by the respective electric power consumer are separately collected in at least two periods, i.e., the first half period, and the second half period in the electric power consumer data collection step, the total electric energy consumption and the degree of load contribution are classified by m and n in the respective periods in the consumed electric energy classification step and the degree-of-load-contribution classification step, the electric power consumers are divided into m×n classes in the respective periods and the electric power consumers are subdivided into smaller classes according to the classes to which the electric power consumers belong in the first half period and the second half period in the electric power consumer classification step, and the relationships between the subdivided respective classes and the respective information are analyzed in the data mining process step. For this reason, with respect to the subdivided classes which include the contents of the changes in status of the electric power consumers, it is possible to analyze at high accuracy, by which specific information which is related to the electric power consumers, the electric power consumers who belong to the classes are characterized, and information which maximally affects the respective class can be specified. As a result, a more exact countermeasure according to respective class, i.e., according to the changes in status of the electric power consumers, can be performed.

In the electric power consumer data collection step, the results of the electric energy consumption of respective electric power consumer in the daytime or the results of the electric energy consumption in the nighttime are collected in a predetermined period. For this reason, it is frequent that the consumed electric energy of each electric power consumer in the daytime and the nighttime are considerably different from each other. The results of the electric energy consumption are separately collected in the daytime and the nighttime, so that the values of the electric power consumers in the electric power market when viewed from an electric power supplier can be measured at higher accuracy.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An electric power consumer data analyzing method realized in the electric power market in which a plurality of electric power consumers purchase electric power from an electric power supplier, the method comprising:
an electric power consumer data collection step of collecting data on electric energy consumption by the respective electric power consumer in a predetermined period;
a consumed electric energy classification step of classifying total electric energy consumption by the electric power consumers in said period into m levels;
a degree-of-load-contribution classification step of classifying degree of load contribution of the electric power consumers in consideration of at least load factors of the load factors which are ratios of average values of the consumed electric energy of the electric power consumers in said period to the maximum values of the consumed electric energy and uniformity coefficient which are ratios of sum totals of the maximum values of the consumed electric energy of the electric power consumers who belong to the same level of the consumed electric energy in said period into n levels;
an electric power consumer classification step of dividing the respective electric power consumers into m×n number of classes based on the classification steps; and
an outputting step of outputting a result obtained in the electric power consumer classification step to a display unit for displaying or a storage unit for storing the results.

2. The electric power consumer data analysis method according to claim 1, wherein the degree of load contribution is calculated using
degree of load contribution=α×(load factor)+(1−α)×(uniformity coefficient)
where α is a coefficient which expresses a predetermined weight and 0<α≦1.

3. The electric power consumer data analysis method according to claim 1 further comprising expressing data of the electric power consumers who correspond to the m×n classes in a form of a map.

4. The electric power consumer data analysis method according to claim 1! wherein
in the electric power consumer data collection step, the data on electric energy consumption by the respective electric power consumer are separately collected in at least in two periods of a first period and a second period;
in the consumed electric energy classification step and the degree-of-load-contribution classification step, the total electric energy consumption is classified into m levels and the degree of load contribution is classified into n levels in the first and second periods; and
in the electric power consumer classification step, the respective electric power consumers are classified into m×n number of classes in the first and second periods.

5. The electric power consumer data analysis method according to claim 1 further comprising a data mining process step of acquiring information related to the electric power consumers and analyzing a relationships between the classes and the information on the basis of the information.

6. The electric power consumer data analysis method according to claim 5, wherein the data mining process step includes a decision tree analysis process step of calculating the relationships between the classes and data contents of the information in a form of a tree.

7. The electric power consumer data analyzing method according to claim 5, wherein the data mining process step includes
a neural network process step which has data contents of the information of the electric power consumers who belong to the classes as an input layer, the classes to which the electric power consumers belong as an output layer, and an intermediate layer between the input layer and the output layer; and
a network leaning process step of inputting the data contents of the information into the input layer and calculating a weight coefficient of the intermediate layer on the basis of the classes which are output from the output layer and to which the electric power consumers belong.

8. The electric power consumer data analysis method according to claim 5, wherein
in the electric power consumer data collection step, the data on electric energy consumption by the respective electric power consumer are separately collected in at least in two periods of a first period and a second period;
in the consumed electric energy classification step and the degree-of-load-contribution classification step, the total electric energy consumption is classified into m levels and the degree of load contribution is classified into n levels in the first and second periods;
in the electric power consumer classification step, the respective electric power consumers are classified into m×n number of classes in the first and second periods and the electric power consumers are subdivided into smaller classes according to the classes to which the electric power consumers belong in the first period; and
the second period and the respective relationships between the subdivided respective classes and the respective information are analyzed in the data mining process step.

9. The electric power consumer data analysis method according to claim 1, wherein in the electric power consumer data collection step, the data on electric energy consumption by the respective electric power consumer in the daytime or the nighttime are collected in a predetermined period.
